(19) United States
(12) Patent Application Publication
(10) Pub. No.: US 2026/0200453 A1
(43) Pub. Date: Jul. 16, 2026

(54) ELECTRONIC PARKING BRAKE DEVICE AND MOVING OBJECT INCLUDING THE SAME

(71) Applicant: HYUNDAI MOBIS CO., LTD., Seoul (KR)

(72) Inventor: Jin Hyo Park, Yongin-si (KR)

(73) Assignee: HYUNDAI MOBIS CO., LTD., Seoul (KR)

(21) Appl. No.: 19/340,209

(22) Filed: Sep. 25, 2025

(30) Foreign Application Priority Data
Jan. 14, 2025 (KR) 10-2025-0005272

(51) Int. Cl. B60T 17/22; B60T 13/74

(52) U.S. Cl. CPC B60T 17/221; B60T 13/74

(57) ABSTRACT

Proposed is an electronic parking brake device for a moving object. The electronic parking brake device includes a measuring device that measures a voltage or a current of a motor for an electronic parking brake, and a controller that detects whether an open failure of the motor has occurred based on the measured voltage or current, and the controller determines whether the open failure of the motor has occurred based on whether the voltage of the motor falls within a reference range in a non-operation mode state of the electronic parking brake.

This application claims the benefit of Korean Patent Application No. 10-2025-0005272, filed on Jan. 14, 2025, which is hereby incorporated by reference as if fully set forth herein.

### BACKGROUND OF THE DISCLOSURE

### Field of the Disclosure

The present disclosure relates to an electronic parking brake device and a moving object including the same, and more particularly, to a device for determining an open failure of a motor of an electronic parking brake and a moving object including the same.

### Discussion of the Related Art

An EPB refers to an electronic parking brake and is a system that electronically controls a parking brake of a vehicle. It replaces an existing manual parking brake (a hand brake or a foot brake) and is designed to increase convenience and safety.

The EPB may be composed of an EPB switch, an electronic control unit, a brake actuator, and/or a sensor. The EPB switch is a switch that allows a driver to operate or release the brake, and is usually designed in a form of a button, so that the brake operates when the EPB switch is simply pressed or pulled. The electronic control unit is a control device of the EPB, and processes signals input from the sensor and the switch and controls the brake actuator (a motor). The brake actuator is designed to operate a brake pad using an electric motor, and physically operates the parking brake to prevent a movement of a moving object or the vehicle. The sensor is a sensor that senses a state of the vehicle, and may not be dedicated to the EPB. For example, the sensor is designed to collect information such as a vehicle speed, an inclination, a transmission position, and the like, which may be used as activation conditions of the EPB operation or the like.

A common failure code in such an EPB is an open failure of the motor. It is intended to provide a method for increasing accuracy of determining such a motor open failure.

### SUMMARY OF THE DISCLOSURE

The present disclosure is intended to propose an electronic parking brake driving device and a moving object including the same.

Problems to be solved of the present disclosure are not limited to the problems described above. Other problems not described above may be understood by those skilled in the art from a following description of the present disclosure.

According to an embodiment of the present disclosure, an electronic parking brake device for a moving object is proposed. The electronic parking brake device may include a measuring device that measures a voltage or a current of a motor for an electronic parking brake, and a controller that detects whether an open failure of the motor has occurred based on the measured voltage or current, and the controller determines whether the open failure of the motor has occurred based on whether the voltage of the motor falls within a reference range in a non-operation mode state of the electronic parking brake.

Additionally or alternatively, the controller may start a timer having a preset time length in response to detecting a release command of the electronic parking brake.

Additionally or alternatively, the controller may determine whether the voltage of the motor falls within the reference range when a preset first time period elapses after a release command of the electronic parking brake is detected and the current flowing through the motor of the electronic parking brake is maintained below a preset value for a preset second time period.

Additionally or alternatively, the controller may determine that the open failure of the motor has occurred in response to that the voltage of the motor does not fall within the reference range.

Additionally or alternatively, the controller may determine that the motor is operating normally in response to that the voltage of the motor falls within the reference range.

Additionally or alternatively, the controller may generate a corresponding failure code upon determining that the open failure of the motor has occurred.

Additionally or alternatively, the electronic parking brake may have or maintain one of an applied mode, a release mode, and a non-operation mode, and the non-operation mode may be a mode that the electronic parking brake has or maintains after an end of the release mode.

Additionally or alternatively, the voltage of the motor may include voltage across terminals of the motor.

According to another embodiment of the present disclosure, a method for an electronic parking brake device to determine an open failure of a motor is proposed. The method includes measuring a voltage or a current of the motor, and detecting whether an open failure of the motor has occurred based on the measured voltage or current, and whether the open failure of the motor has occurred is determined based on whether the voltage of the motor falls within a reference range in a non-operation mode state of an electronic parking brake.

According to another embodiment of the present disclosure, a moving object including an electronic parking brake device is proposed. In the moving object, the electronic parking brake device includes a measuring device that measures a voltage or a current of a motor for an electronic parking brake, and a controller that detects whether an open failure of the motor has occurred based on the measured voltage or current, and wherein the controller determines whether the open failure of the motor has occurred based on whether the voltage of the motor falls within a reference range in a non-operation mode state of the electronic parking brake.

The above-described solutions of the present disclosure are part of the embodiments of the present disclosure. Various solutions other than the above-described solutions may be derived and understood based on a detailed description of the present disclosure to be described below.

The present disclosure has following effects.

The present disclosure may more accurately detect the motor open failure of the electronic parking brake, thereby preventing a false warning.

Effects of the present disclosure are not limited to the effects described above. Other effects not described above may be understood by those skilled in the art from a description of the present disclosure below.

### BRIEF DESCRIPTION OF THE DRAWINGS

The accompanying drawings, which are included as part of the detailed description to help understand the present disclosure, provide embodiments of the present disclosure, and illustrate contents of the present disclosure together with the detailed description.

FIG. 1 briefly illustrates a motor circuit of an electronic parking brake (EPB).

FIG. 2 shows an EPB operation command when an EPB motor is normal, and measured values of voltage across terminals of the motor and a current flowing through the motor based on the command.

FIG. 3 shows an EPB operation command when an EPB motor has failed, and measured values of voltage across terminals of the motor and a current flowing through the motor based on the command.

FIG. 4 is a flowchart of a method for detecting an EPB motor open failure according to the present disclosure.

FIG. 5 shows a block diagram of a device for detecting an EPB motor open failure according to the present disclosure.

### DETAILED DESCRIPTION OF THE DISCLOSURE

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

In addition, in the specification, “occupant”, “passenger”, “driver”, “user”, etc. are mentioned for description of the present disclosure, and may be used interchangeably therewith.

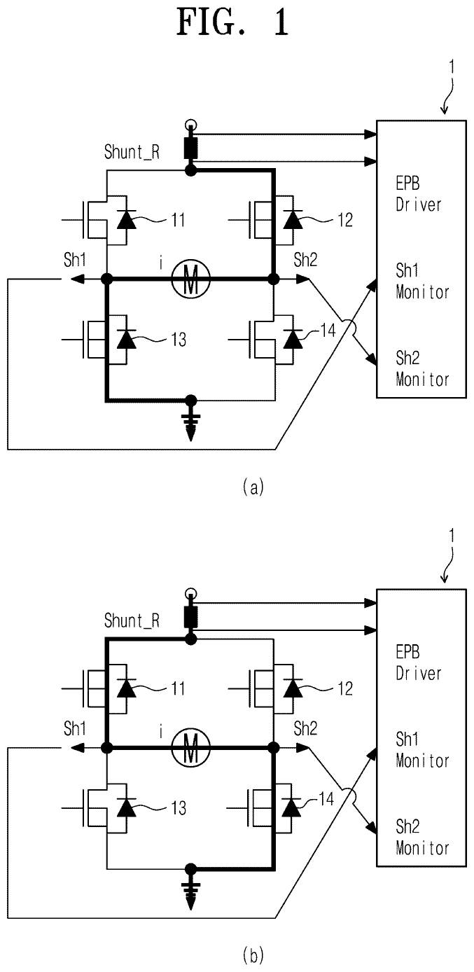

FIG. 1 briefly illustrates a motor circuit of an electronic parking brake (EPB).

(a) and (b) in FIG. 1 illustrate motor driving circuits 11, 12, 13, and 14 and a driver 1 for driving an EPB. A motor M allows a current to flow therethrough based on switching operations of the motor driving circuits 11, 12, 13, and 14, and rotates accordingly. The driver 1 may control a rotation direction of the motor by controlling gate voltages applied to respective transistors of the motor driving circuits 11, 12, 13, and 14 to simultaneously turn on or off transistors 11 and 14 or 12 and 13 arranged in a diagonal direction. In addition, the driver 1 may turn off or turn on upper transistors 11 and 12 or lower transistors 13 and 14 of the motor driving circuits, thereby making voltages at terminals of the motor M equal, that is, shorted, which corresponds to a state in which the rotation is stopped.

(a) in FIG. 1 illustrates a current flow from the driver 1 when the motor M rotates in a first direction, and (b) in FIG. 1 illustrates a current flow from the driver 1 when the motor M rotates in a second direction (opposite to the first direction). In each diagram, a thick arrow passing through the motor M indicates the current flow.

One of the rotation in the first direction and the rotation in the second direction is an applied mode, that is, a mode in which a brake pad is operated by the rotation of the motor to limit a movement of a moving object, and the other is a release mode, that is, a mode in which the brake pad is released by a reverse rotation of the motor to enable the movement of the moving object. After the release mode is maintained for a predetermined time period, the EPB enters a non-operation mode, which is implemented by controlling the voltages at both terminals of the motor to be equal to each other as described above.

In addition, the driver 1 detects a current of the motor driving circuit, that is, a current flowing through a shunt resistor Shunt_R, and detects voltages Sh1 and Sh2 at both terminals of the motor. The driver 1 may determine whether the EPB or the EPB motor has failed or is normal using the detected current and voltages.

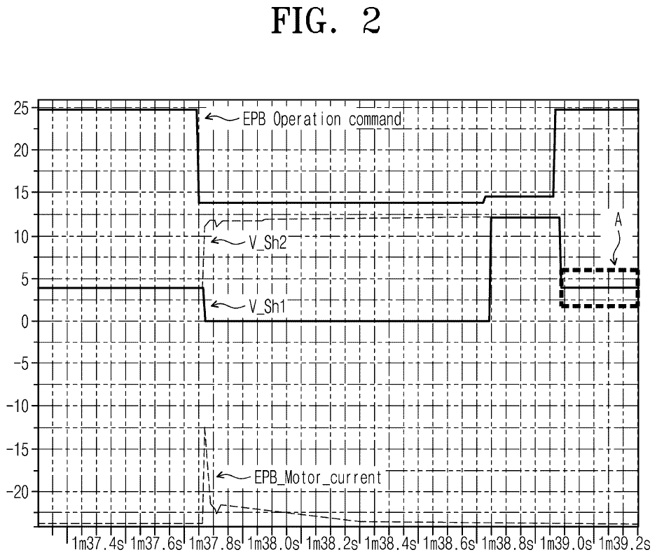

FIG. 2 shows an EPB operation command when an EPB motor is normal, and measured values of voltage across terminals of the motor and a current flowing through the motor based on the command.

V_Sh1 is a left end voltage of the motor M shown in FIG. 1, and V_Sh2 is a right end voltage of the motor M shown in FIG. 1. An x-axis represents time, and a y-axis represents a magnitude of a signal, a voltage value, or a current value.

The graph will be described based on passage of time. V_Sh1 and V_Sh2 are maintained with a value of about 4V. Then, as the EPB operation command (a release command) is detected, the motor M needs to be driven or rotated, so that the driver 1 may control the gate voltage or the like input into the transistor of the motor driving circuit to generate a difference between the voltage values of V_Sh1 and V_Sh2. Accordingly, the motor M is rotated.

EPB_Motor_current represents the current flowing through the motor driving circuit (i.e., the current flowing through the shunt resistor). It may be identified that a high current flows initially based on the rotation of the motor M and then the current gradually stabilizes.

Then, the driver 1 may again control V_Sh1 and V_Sh2 to be equal to each other (i.e., short-circuit both terminals of the motor), and control the voltage level thereof to be about 4V again (A).

However, in the past, the voltage value of the period indicated by A was not checked, and only a magnitude of the EPB_Motor_current for a predetermined time period after input or detection of the EPB operation command (the release command) was used as a condition for detecting an open failure of the EPB or the EPB motor. Because there is little load on the motor M at an end of an EPB release period, even when the EPB or the EPB motor is in the normal state, the flowing current value is very small and fine noise in the shunt resistor Shunt_R for the current detection also has an effect thereon. Therefore, there was a problem of a misjudgment of the failure, even though the open failure has not occurred in the EPB or the EPB motor.

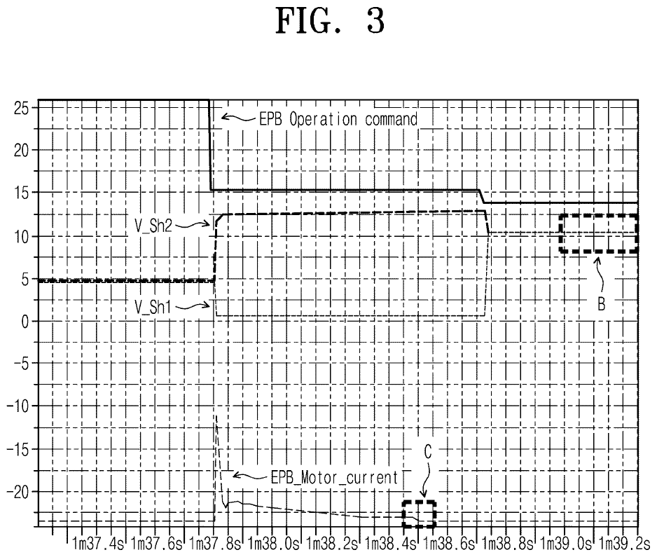

FIG. 3 shows an EPB operation command when an EPB motor has failed, and measured values of voltage across terminals of the motor and a current flowing through the motor based on the command.

Because information represented by each line of a graph is the same as that in FIG. 2, FIG. 2 will be referred to.

FIG. 3 is different from FIG. 2 in that when the EPB motor fails, a current drop as in C actually occurs, and a motor phase voltage V_Sh1 or V_Sh2 is controlled to be about 10V as in B. Accordingly, the present disclosure proposes to determine the open failure of the EPB or the EPB motor by utilizing an additional condition using the value of the motor phase voltage V_Sh1 or V_Sh2 in the non-operation mode after a predetermined time elapses following the detection of the input of the release command.

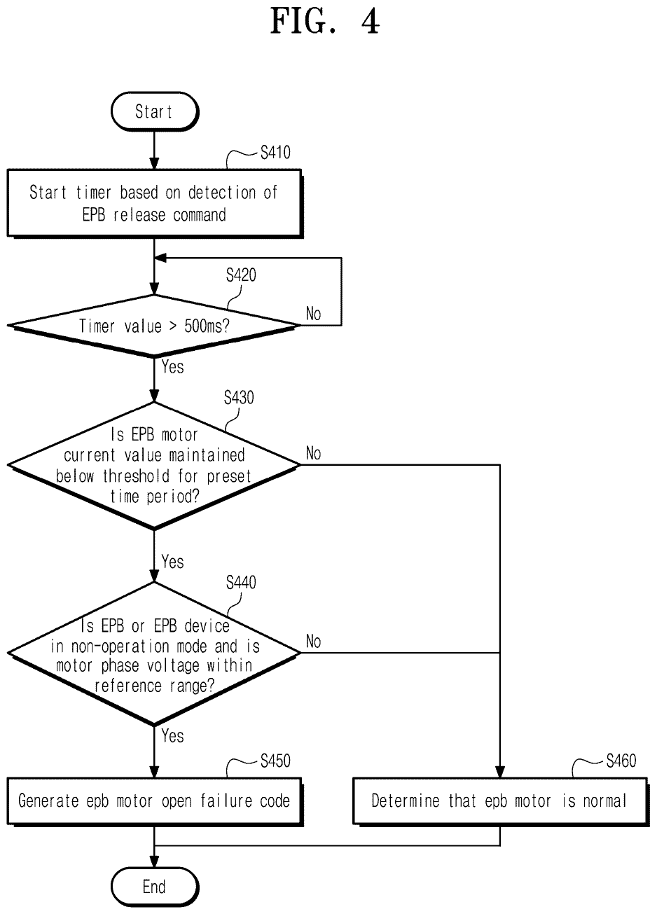

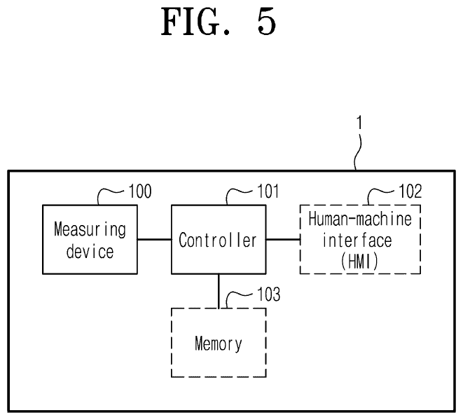

FIG. 4 is a flowchart of a method for detecting an EPB motor open failure according to the present disclosure. The method for detecting the EPB motor open failure may be performed by an EPB device, a controller of the EPB device, or the driver of the EPB. Hereinafter, it will be described that the method in FIG. 4 is performed by an EPB device 1. The EPB device 1 will be described with reference to FIG. 5.

The EPB device 1 may detect the EPB release command. The EPB release command may be input via manipulation of an EPB switch by a user or a driver, or may be input by a controller of the moving object.

The EPB device 1 may start a timer based on the input of the EPB release command or the detection thereof (S410).

The EPB device 1 may determine whether a value of the timer exceeds a preset first time period 500 ms (S420). When the value of the timer does not exceed the preset first time period, the EPB device 1 may wait until the timer value exceeds the preset first time period.

As the value of the timer exceeds the preset first time period, the EPB device 1 may determine whether the value of the current flowing through the motor of the EPB is maintained below a threshold for a preset second time period (S430). When it is determined that the value of the current flowing through the motor of EPB is not maintained below the threshold for the preset second time period, the motor of the EPB may be determined to be normal (S460).

When it is determined that the value of the current flowing through the motor of the EPB is maintained below the threshold for the preset second time period, the EPB device 1 may determine whether the EPB or the EPB device is in the non-operation mode and the motor phase voltage falls within a reference range (S440). When it is determined that the EPB or the EPB device is not in the non-operation mode or that the motor phase voltage does not fall within the reference range even the EPB or the EPB device is in the non-operation mode, the motor of the EPB may be determined to be normal (S460).

When it is determined that the EPB or the EPB device is in the non-operation mode and the motor phase voltage falls within the reference range, the EPB device 1 may determine that the motor of the EPB has failed and generate an EPB motor open failure code (S450).

As such, by adding S440, an error of determining that the open failure has occurred in the motor of the EPB even in the normal state illustrated in FIG. 2 may be avoided.

FIG. 5 shows a block diagram of a device for detecting an EPB motor open failure according to the present disclosure.

The EPB device 1 may include a measuring device 100 designed to measure the voltage or the current of the motor for the electronic parking brake.

In addition, the EPB device 1 may include a controller 101 designed to detect whether the open failure of the motor for the electronic parking brake has occurred based on the measured voltage or current.

The controller 101 may be designed to determine whether the open failure of the motor has occurred based on whether the voltage of the motor of the electronic parking brake falls within the reference range in the non-operation mode of the electronic parking brake.

The controller 101 may be designed to start the timer having a preset time period length as the release command of the electronic parking brake is input or detected.

The controller 101 may be designed to determine whether the voltage of the motor of the electronic parking brake falls within the reference range when the preset first time period elapses after the release command of the electronic parking brake is detected and the current flowing through the motor of the electronic parking brake is maintained below the preset value for the preset second time period.

The controller 101 may be designed to determine that the open failure of the motor of the electronic parking brake has occurred as the voltage of the motor of the electronic parking brake does not fall within the reference range.

The controller 101 may determine that the motor of the electronic parking brake operates normally as the voltage of the motor of the electronic parking brake falls within the reference range.

The controller 101 may be designed to generate the corresponding failure code upon determining that the open failure of the motor has occurred.

The electronic parking brake is designed to have or maintain one of the applied mode, the release mode, and the non-operation mode, and the non-operation mode is a mode that the electronic parking brake has or maintains after the end of the release mode. The release mode is a mode in which the movement of the moving object is not restricted by releasing the pad of the electronic parking brake, and the applied mode is a mode in which the movement of the moving object is restricted by operating the pad of the electronic parking brake.

The voltage of the motor of the electronic parking brake may include the voltage across terminals of the motor.

In addition, the EPB device 1 may further include a human-machine interface (HMI) 102 designed to output the failure code.

In addition, the EPB device 1 may further include a memory 103 designed to store a code for executing an operation or a logic for detecting, by the controller 101, whether the open failure of the motor for the electronic parking brake has occurred, as described above.

The contents of the present disclosure described above with reference to FIGS. 1 to 4, which have not been described with reference to FIG. 5, may be applied to the electronic parking brake device 1 or the controller 101 thereof.

As another embodiment of the present disclosure, a moving object or a vehicle 1000 including the electronic parking brake device 1 described above is proposed.

Although it has been described herein that the “device” for detecting the failure of the electronic parking brake device or each component included therein performs the control, the “device” and the components included therein are only names, and the scope of rights is not dependent thereon.

In other words, the proposed technology of the present disclosure may be performed by devices having names other than the processor, controller, etc. In addition, the method, scheme, or the like described above may be performed by software or code readable by a computer or other machine or device for detecting the failure of the electronic parking brake device.

In addition, as another aspect of the present disclosure, the operation of the proposed technology described above may be provided as code that may be implemented, realized, or executed by a “computer” (a generic concept including a system on chip (SoC) or a (micro) processor) or a computer-readable storage medium, a computer program product, or the like storing or containing the code. The scope of the present disclosure is extendable to the code or the computer-readable storage medium or the computer program product storing or containing the code.

Detailed descriptions of preferred embodiments of the present disclosure disclosed as described above have been provided such that those skilled in the art may implement and realize the present disclosure.

Although the present disclosure has been described above with reference to preferred embodiments, those skilled in the art will understand that various modifications and changes can be made to the present disclosure set forth in the claims below.

Accordingly, the present disclosure is not intended to be limited to the embodiments shown herein but is to be accorded the widest scope consistent with the principles and novel features disclosed herein.

What is claimed is:

1. An electronic parking brake device for a moving object, the electronic parking brake device comprising:
a measuring device configured to measure a voltage or a current of a motor for an electronic parking brake; and
a controller configured to detect whether an open failure of the motor has occurred based on the measured voltage or current,
wherein the controller is further configured to determine whether the open failure of the motor has occurred based on whether the voltage of the motor falls within a reference range in a non-operation mode state of the electronic parking brake.

2. The electronic parking brake device of claim 1, wherein the controller is further configured to start a timer having a preset time length based on detecting a release command of the electronic parking brake.

3. The electronic parking brake device of claim 1, wherein the controller is further configured to determine whether the voltage of the motor falls within the reference range based on that a preset first time period elapses after a release command of the electronic parking brake is detected and the current flowing through the motor of the electronic parking brake is maintained below a preset value for a preset second time period.

4. The electronic parking brake device of claim 1, wherein the controller is further configured to determine that the open failure of the motor has occurred based on that the voltage of the motor does not fall within the reference range.

5. The electronic parking brake device of claim 1, wherein the controller is further configured to determine that the motor is operating normally based on that the voltage of the motor falls within the reference range.

6. The electronic parking brake device of claim 4, wherein the controller is further configured to generate a corresponding failure code upon determining that the open failure of the motor has occurred.

7. The electronic parking brake device of claim 1, wherein the electronic parking brake is configured to have or maintain one of an applied mode, a release mode, and a non-operation mode,
wherein the non-operation mode is a mode that the electronic parking brake has or maintains after an end of the release mode.

8. The electronic parking brake device of claim 1, wherein the voltage of the motor includes voltage across terminals of the motor.

9. A method for an electronic parking brake device to determine an open failure of a motor, the method comprising:
measuring a voltage or a current of the motor; and
determining, by a controller, whether an open failure of the motor has occurred based on the measured voltage or current,
wherein whether the open failure of the motor has occurred is determined based on whether the voltage of the motor falls within a reference range in a non-operation mode state of an electronic parking brake.

10. The method of claim 9, further comprising starting, by the controller, a timer having a preset time length based on detecting a release command of the electronic parking brake.

11. The method of claim 9, further comprising determining, by the controller, whether the voltage of the motor falls within the reference range based on that a preset first time period elapses after a release command of the electronic parking brake is detected and the current flowing through the motor of the electronic parking brake is maintained below a preset value for a preset second time period.

12. The method of claim 9, further comprising determining, by the controller, that the open failure of the motor has occurred based on that the voltage of the motor does not fall within the reference range.

13. The method of claim 9, further comprising determining, by the controller, that the motor is operating normally based on that the voltage of the motor falls within the reference range.

14. The method of claim 12, further comprising generating, by the controller, a corresponding failure code upon determining that the open failure of the motor has occurred.

15. The method of claim 9, wherein the electronic parking brake is configured to have or maintain one of an applied mode, a release mode, and a non-operation mode,
wherein the non-operation mode is a mode that the electronic parking brake has or maintains after an end of the release mode.

16. The method of claim 9, wherein the voltage of the motor includes voltage across terminals of the motor.

17. A moving object including an electronic parking brake device, wherein the electronic parking brake device includes:
a measuring device configured to measure a voltage or a current of a motor for an electronic parking brake; and
a controller configured to detect whether an open failure of the motor has occurred based on the measured voltage or current,
wherein the controller is further configured to determine whether the open failure of the motor has occurred based on whether the voltage of the motor falls within a reference range in a non-operation mode state of the electronic parking brake.

18. The moving object of claim 17, wherein the controller is further configured to start a timer having a preset time length based on detecting a release command of the electronic parking brake.

19. The moving object of claim 17, wherein the controller is further configured to determine whether the voltage of the motor falls within the reference range based on that a preset first time period elapses after a release command of the electronic parking brake is detected and the current flowing through the motor of the electronic parking brake is maintained below a preset value for a preset second time period.

20. The moving object of claim 17, wherein the controller is further configured to determine that the open failure of the motor has occurred based on that the voltage of the motor does not fall within the reference range.
